(19) United States
(12) Patent Application Publication
(10) Pub. No.: US 2026/0101151 A1
(43) Pub. Date: Apr. 9, 2026

(54) AUDIO SIGNAL PROCESSOR

(71) Applicant: ALPS ALPINE CO., LTD., Tokyo (JP)

(72) Inventors: Kazumasa NIHIRA, Tokyo (JP); Keita TANNO, Tokyo (JP)

(21) Appl. No.: 19/348,138

(22) Filed: Oct. 2, 2025

(30) Foreign Application Priority Data
Oct. 9, 2024 (JP) 2024-176976

(51) Int. Cl. H04S 7/00; H04S 1/00

(52) U.S. Cl. CPC H04S 7/307; H04S 1/007; H04S 7/302; H04S 2400/11; H04S 2420/01

(57) ABSTRACT

An audio signal processor includes a harmonic signal generator to generate a harmonic signal that includes a signal generated by frequency scaling components of a target audio signal by a factor of k, a left audio signal generator to generate a left audio signal by convolving a head-related transfer function from a target localization position of the target audio signal to a left ear of a listener with the target audio signal, a right audio signal generator to generate a right audio signal by convolving a head-related transfer function from the target localization position to a right ear of the listener with the target audio signal, a left synthesizer to generate a left channel audio signal by synthesizing the left audio signal and the harmonic signal, and a right synthesizer to generate a right channel audio signal by synthesizing the right audio signal and the harmonic signal.

### CROSS-REFERENCE TO RELATED APPLICATION

The present application is based on and claims priority to Japanese patent application no. 2024-176976 filed on October 9, 2024, with the Japan Patent Office, the entire contents of which are hereby incorporated by reference.

### BACKGROUND OF THE INVENTION

### 1. Field of the Invention

The disclosures herein relate to audio signal processors.

### 2. Description of the Related Art

An audio signal processor is known which provides sound image localization at a target position by convolving an acoustic transfer characteristic (head-related transfer function) from the target position to a listener’s left and right ears with an audio signal and outputting the result (e.g., Patent Literature (PTL) 1).

Since a human’s ability to perceive the direction of narrowband sounds is limited, even if a head-related transfer function is convolved with a narrowband audio signal and the result is output as described above, it may fail to provide a sufficient sense of localization.

In addition, when the head-related transfer function is convolved with an audio signal and output, the perceived sound quality of the output sound may be different from that of the original audio signal. An object of the present invention is to achieve a preferable sense of localization while maintaining the perceived sound quality of the audio signal.

### CITATION LIST

### PATENT LITERATURE

[PTL 1] Japanese Patent no. 3395809

### SUMMARY OF THE INVENTION

An audio signal processor includes a harmonic signal generator configured to generate a harmonic signal that includes a signal generated by frequency scaling components of a target audio signal by a factor of k (k is an integer equal to or more than 2), the target audio signal being an audio signal to be processed, a left audio signal generator configured to generate a left audio signal by convolving a head-related transfer function from a target localization position of the target audio signal to a left ear of a listener with the target audio signal, a right audio signal generator configured to generate a right audio signal by convolving a head-related transfer function from the target localization position to a right ear of the listener with the target audio signal, a left synthesizer configured to generate a left channel audio signal by synthesizing the left audio signal and the harmonic signal, and a right synthesizer configured to generate a right channel audio signal by synthesizing the right audio signal and the harmonic signal.

An audio signal processor includes a harmonic signal generator configured to generate a harmonic signal that includes a signal generated by frequency scaling components of a target audio signal by a factor of k (k is an integer equal to or more than 2), the target audio signal being an audio signal to be processed, a left harmonic signal generator configured to generate a left harmonic signal by adjusting a gain of the harmonic signal in accordance with a direction of a target localization position of the target audio signal, such that the gain increases as the direction shifts leftward, a right harmonic signal generator configured to generate a right harmonic signal by adjusting a gain of the harmonic signal in accordance with the direction of the target localization position of the target audio signal, such that the gain increases as the direction shifts rightward, a left audio signal generator configured to generate a left audio signal by convolving a head-related transfer function from the target localization position to a left ear of a listener with the target audio signal, a right audio signal generator configured to generate a right audio signal by convolving a head-related transfer function from the target localization position to a right ear of the listener with the target audio signal, a left synthesizer configured to generate a left channel audio signal by synthesizing the left audio signal and the left harmonic signal, and a right synthesizer configured to generate a right channel audio signal by synthesizing the right audio signal and the right harmonic signal.

An audio signal processor includes a harmonic signal generator configured to generate a harmonic signal that includes a signal generated by frequency scaling components of a target audio signal by a factor of k (k is an integer equal to or more than 2), the target audio signal being an audio signal to be processed, a harmonic additional signal synthesizer configured to generate a harmonic additional signal by synthesizing the target audio signal and the harmonic signal, a left channel audio signal generator configured to generate an audio signal of a left channel by convolving a head-related transfer function from a target localization position of the target audio signal to a left ear of a listener with the harmonic additional signal, and a right channel audio signal generator configured to generate an audio signal of a right channel by convolving a head-related transfer function from the target localization position of the target audio signal to a right ear of the listener with the harmonic additional signal.

An audio signal processor includes a left harmonic signal generator configured to generate a left harmonic signal generated by frequency scaling components of a target left channel signal by a factor of k (k is an integer equal to or more than 2), the target left channel signal being a left channel signal of a target audio signal including left and right channels to be processed, a right harmonic signal generator configured to generate a right harmonic signal generated by frequency scaling components of a target right channel signal by a factor of L (L is an integer equal to or more than 2), the target right channel signal being the right signal of the target audio signal, a left audio signal generator configured to generate a left audio signal by convolving a head-related transfer function from a target localization position of the target audio signal to a left ear of a listener with the target left channel signal, a right audio signal generator configured to generate a right audio signal by convolving a head-related transfer function from the target localization position to a right ear of the listener with the target right channel signal, a left synthesizer configured to generate a left channel audio signal by synthesizing the left audio signal and the left harmonic signal, and a right synthesizer configured to generate a right channel audio signal by synthesizing the right audio signal and the right harmonic signal.

An audio signal processor includes a left harmonic signal generator configured to generate a left harmonic signal generated by frequency scaling components of a target left channel signal by a factor of k (k is an integer equal to or more than 2), the target left channel signal being a left channel signal of a target audio signal including left and right channels to be processed, a right harmonic signal generator configured to generate a right harmonic signal generated by frequency scaling components of a target right channel signal by a factor of L (L is an integer equal to or more than 2), the target right channel signal being the right signal of the target audio signal, a left harmonic additional signal synthesizer configured to generate a left harmonic additional signal by synthesizing the target left channel signal and the left harmonic signal, a right harmonic additional signal synthesizer configured to generate a right harmonic additional signal by synthesizing the target right channel signal and the right harmonic signal, a left channel audio signal generator configured to generate a left channel audio signal by convolving a head-related transfer function from a target localization position of the target audio signal to a left ear of a listener with the left harmonic additional signal, and a right channel audio signal generator configured to generate a right channel audio signal by convolving a head-related transfer function from the target localization position to a right ear of the listener with the right harmonic additional signal.

According to the above-described audio signal processor, the audio signal obtained by synthesizing the signal obtained by convolving the head-related transfer function with the target audio signal which is an audio signal to be processed, and the harmonic signal which is an integral multiple of the frequency of the audio signal to be processed or a signal obtained by convolving the head-related transfer function with the harmonic signal is generated.

Therefore, it is possible to provide a preferable sense of localization by the signal obtained by convolving the head-related transfer function with the target audio signal included in the generated audio signal, and to prevent a perceived sound quality from becoming different from that of the target audio signal caused by the harmonic signal included in the generated audio signal.

As described above, according to the present invention, it is possible to achieve a preferable sense of localization while maintaining a perceived sound quality of the audio signal.

### BRIEF DESCRIPTION OF THE DRAWINGS

FIG. 1 is a drawing illustrating a configuration of an audio signal processor according to an embodiment of the present disclosure;

FIG. 2 is a drawing illustrating another configuration example of the audio signal processor according to the embodiment of the present disclosure;

FIG. 3 is a drawing illustrating a configuration of a harmonic addition unit according to the embodiment of the present disclosure;

FIG. 4 is a drawing illustrating another configuration example of the audio signal processor according to the embodiment of the present disclosure; and

FIG. 5 is a drawing illustrating another configuration example of the audio signal processor according to the embodiment of the present disclosure.

### DESCRIPTION OF THE PREFERRED EMBODIMENTS

In the following, an embodiment of the present invention will be described.

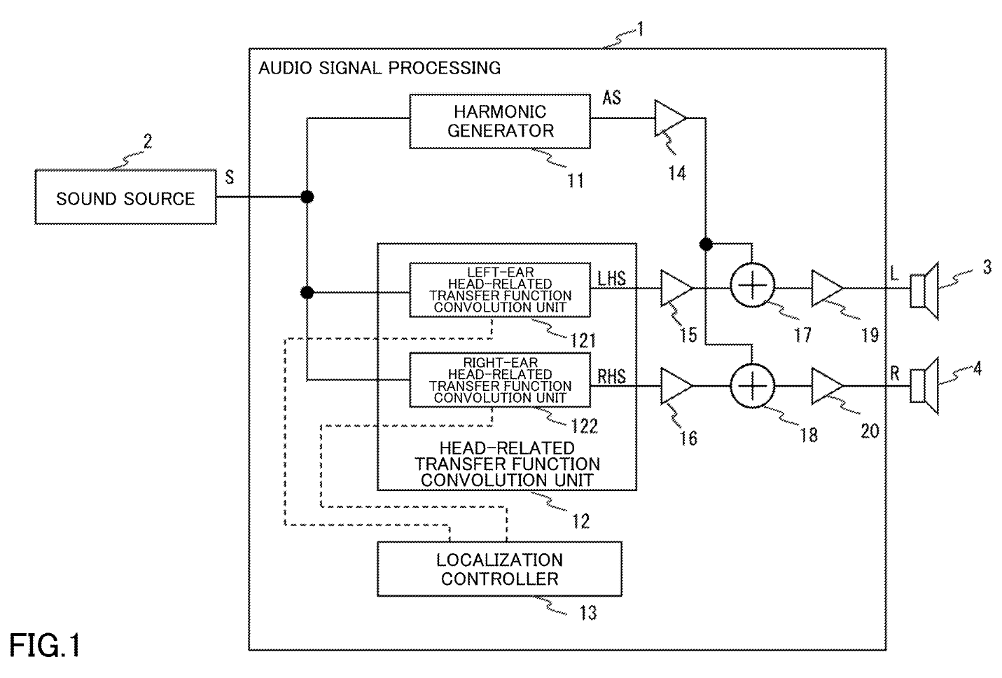

FIG. 1 is a drawing illustrating a configuration of an audio signal processor 1 according to the embodiment of the present disclosure.

As shown in the figure, the audio signal processor 1 that applies signal processing to a one-channel audio signal S output from a sound source 2 to provide a sense of localization, generates two-channel audio signals (L (left) and R (right)), and outputs the signals to a left speaker 3 and a right speaker 4.

The audio signal processor 1 includes a harmonic generator 11, a head-related transfer function convolution unit 12, a localization controller 13, a harmonic amplifier 14, an L-channel signal amplifier 15, an R-channel signal amplifier 16, an L-channel synthesizer 17, an R-channel synthesizer 18, an L-channel output amplifier 19, and an R-channel output amplifier 20.

The head-related transfer function convolution unit 12 includes a left-ear head-related transfer function convolution unit 121 and a right-ear head-related transfer function convolution unit 122.

The harmonic generator 11 generates a signal of an i-th harmonic of the audio signal S output from the sound source 2 (harmonic signal), for each integer i from 1 to N (N ≥ 2), combines the generated signals, and outputs the resultant signal as a signal AS.

The harmonic generator 11 may generate a signal of an i-th harmonic of the audio signal S output from the sound source 2 (harmonic signal), where i is one integer of 1 or more, and output the resultant signal as a signal AS.

The level of the signal AS is adjusted with a predetermined gain by the harmonic amplifier 14, and is sent to the L-channel synthesizer 17 and the R-channel synthesizer 18.

The localization controller 13 sets a head-related transfer function from the localization position to a listener’s left ear in the left-ear head-related transfer function convolution unit 121, and sets a head-related transfer function from the localization position to the listener’s right ear in the right-ear head-related transfer function convolution unit 122, in accordance with the set localization position of the sound image of the target audio signal S.

Here, the localization position of the sound image of the target audio signal S may be obtained as a predetermined distance from the localization position to the listener in accordance with the set direction of the localization position with respect to the listener.

The left-ear head-related transfer function convolution unit 121 convolves the head-related transfer function set by the localization controller 13 with the audio signal S output from the sound source 2 and outputs the convolved signal as an audio signal LHS, and the right-ear head-related transfer function convolution unit 122 convolves the head-related transfer function set by the localization controller 13 with the audio signal S output from the sound source 2 and outputs the convolved signal as an audio signal RHS.

The level of the audio signal LHS is adjusted at a predetermined gain by the L-channel signal amplifier 15 and sent to the L-channel synthesizer 17, and the level of the audio signal RHS is adjusted at a predetermined gain by the R-channel signal amplifier 16 and sent to the R-channel synthesizer 18.

The L-channel synthesizer 17 synthesizes the signal AS input from the harmonic amplifier 14 and the audio signal LHS input from the L-channel signal amplifier 15 and outputs the synthesized signal to the left speaker 3 via the L-channel output amplifier 19, and the R-channel synthesizer 18 synthesizes the signal AS input from the harmonic amplifier 14 and the audio signal RHS input from the R-channel signal amplifier 16 and outputs the synthesized signal to the right speaker 4 via the R-channel output amplifier 20.

The gains of the harmonic amplifier 14, the L-channel signal amplifier 15, and the R-channel signal amplifier 16 may be freely adjusted by a user in order to obtain a preferred sense of localization and sound quality.

According to such a configuration of the audio signal processor 1, a signal obtained by convolving the head-related transfer function with the audio signal S output from the sound source 2, which is included in the output of the audio signal processor 1, can provide a preferable sense of localization, while preventing the output of the audio signal processor 1 from becoming of a different nature from the audio signal S due to the harmonic signal generated by the harmonic generator 11, which is included in the output of the audio signal processor 1.

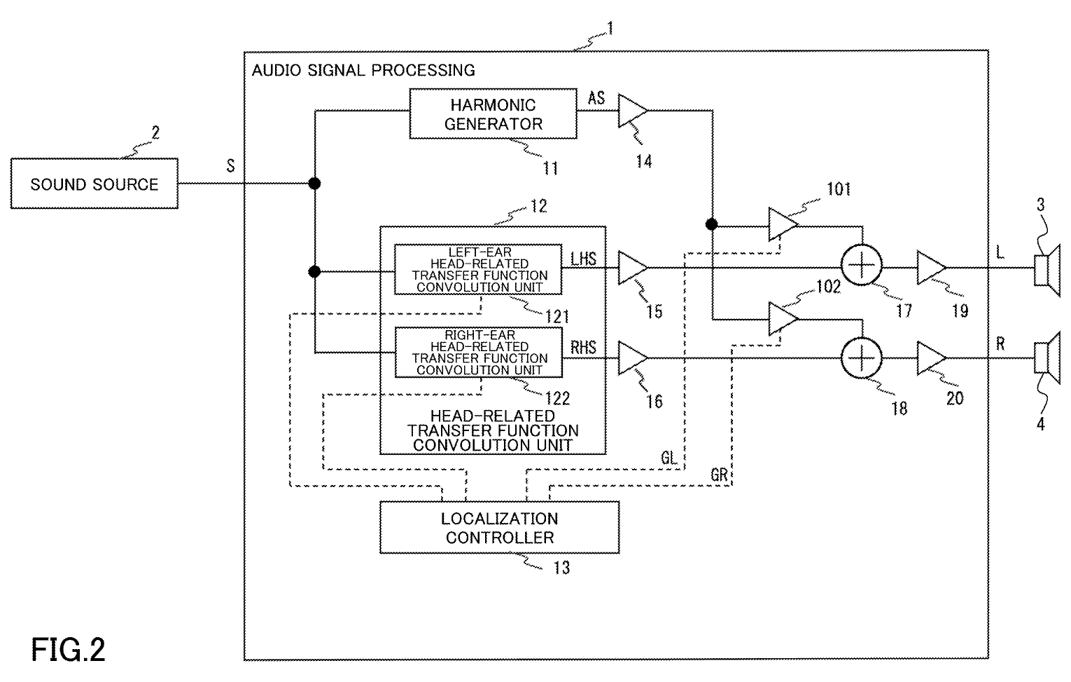

Here, the audio signal processor 1 may be configured as shown in FIG. 2.

As shown in the figure, the audio signal processor 1 is configured by adding an L-channel harmonic adjusting amplifier 101 and an R-channel harmonic adjusting amplifier 102 to the configuration shown in FIG. 1.

The L-channel harmonic adjusting amplifier 101 adjusts the level of the signal AS input from the harmonic amplifier 14 by the gain GL set by the localization controller 13 and outputs the signal to the L-channel synthesizer 17, and the R-channel harmonic adjusting amplifier 102 adjusts the level of the signal AS input from the harmonic amplifier 14 by the gain GR set by the localization controller 13 and outputs the signal to the R-channel synthesizer 18.

The L-channel synthesizer 17 synthesizes the signal AS input from the L-channel harmonic adjusting amplifier 101 and the audio signal LHS input from the L-channel signal amplifier 15, and outputs the synthesized signal to the left speaker 3 via the L-channel output amplifier 19. The R-channel synthesizer 18 synthesizes the signal AS input from the R-channel harmonic adjusting amplifier 102 and the audio signal RHS input from the R-channel signal amplifier 16, and outputs the synthesized signal to the right speaker 4 via the R-channel output amplifier 20.

The localization controller 13 controls the gain GL of the L-channel harmonic adjusting amplifier 101 and the gain GR of the R-channel harmonic adjusting amplifier 102 so that the gain GL increases and the gain GR decreases as the direction is to the left, and the gain GR increases and the gain GL decreases as the direction is to the right, depending on the direction of the localization position of the sound image of the target audio signal S with respect to the listener.

According to such a configuration of the audio signal processor 1, the sound sense of localization expressed by the audio signal S output from the audio signal processor 1 can be further enhanced.

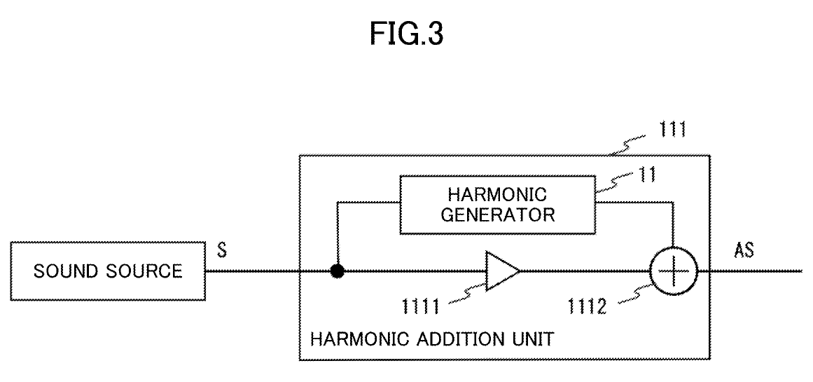

The harmonic generator 11 of the audio signal processor 1 shown in FIGS. 1 and 2 may be replaced with the harmonic addition unit 111 shown in FIG. 3.

As shown in the figure, the harmonic addition unit 111 includes the above-mentioned harmonic generator 11, a fundamental tone level adjusting amplifier 1111, and a harmonic fundamental tone synthesizer 1112.

The fundamental tone level adjusting amplifier 1111 adjusts the level of the audio signal S output from the sound source 2 with a preset gain and outputs the adjusted signal to the harmonic fundamental tone synthesizer 1112. The harmonic fundamental tone synthesizer 1112 synthesizes the output of the harmonic generator 11 with the output of the fundamental tone level adjusting amplifier 1111 and outputs the synthesized signal as a signal AS.

Here, when the gain of the fundamental tone level adjusting amplifier 1111 is set to block the audio signal S, the signal AS output from the harmonic addition unit 111 is equal to the output from the harmonic generator 11. When the gain of the fundamental tone level adjusting amplifier 1111 is set to transmit the audio signal S as it is, the signal AS output from the harmonic addition unit 111 includes a component of the audio signal S as it is.

The fundamental tone level adjusting amplifier gain is set to a pre-adjusted value to obtain a desired relationship between sense of localization and sound quality.

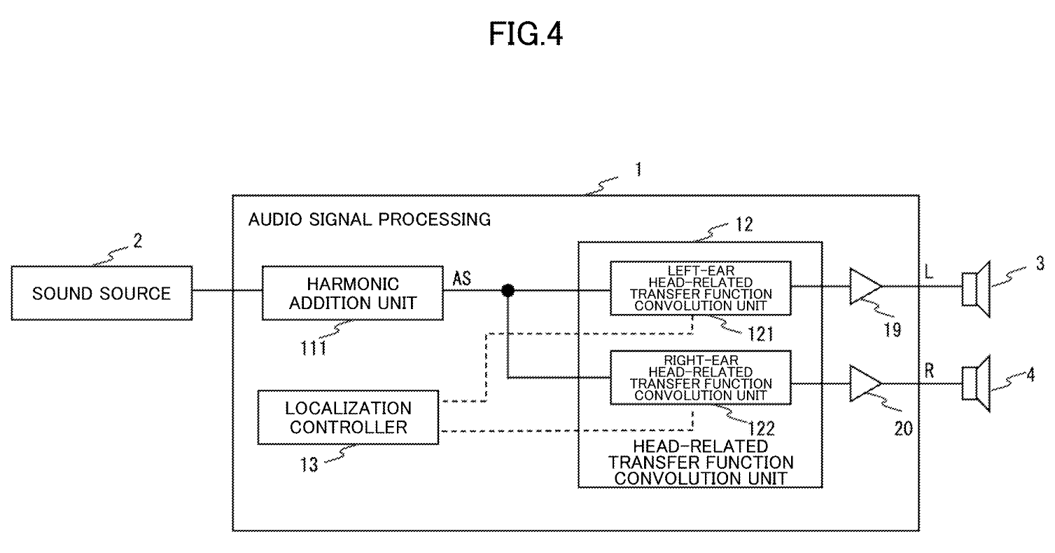

Further, the configuration of the audio signal processor 1 may be changed from the configuration shown in FIG. 1 and FIG. 2 to the configuration shown in FIG. 4.

In the configuration shown in FIG. 4, the audio signal processor 1 includes the harmonic addition unit 111 shown in FIG. 3, the head-related transfer function convolution unit 12, the localization controller 13, the L-channel output amplifier 19, and the R-channel output amplifier 20.

The audio signal S output from the sound source 2 is input to the harmonic addition unit 111, and the output signal AS of the harmonic addition unit 111 is input to both the left-ear head-related transfer function convolution unit 121 and the right-ear head-related transfer function convolution unit 122 of the head-related transfer function convolution unit 12.

The output of the left-ear head-related transfer function convolution unit 121 is output to the left speaker 3 via the L-channel output amplifier 19, and the output of the right-ear head-related transfer function convolution unit 122 is output to the right speaker 4 via the R-channel output amplifier 20.

Here, in the configuration shown in FIG. 4, the fundamental tone level adjusting amplifier 1111 of the harmonic addition unit 111 may be eliminated so that the signal AS output from the harmonic addition unit 111 includes the component of the audio signal S as it is.

Even with such a configuration of the audio signal processor 1, the signal obtained by convolving the head-related transfer function with the audio signal S output from the sound source 2, which is included in the output of the audio signal processor 1, provides a preferable sense of localization, and the signal obtained by convolving the head-related transfer function with the harmonic signal generated by the harmonic generator 11, which is included in the output of the audio signal processor 1, prevents the output of the audio signal processor 1 from becoming of a different nature from the audio signal S to a predetermined extent.

The present embodiment has been described above.

Here, although the case where the sound source 2 outputs the audio signal S of one channel has been described above, the present embodiment can be similarly applied to the case where the sound source 2 outputs the audio signal S of two channels.

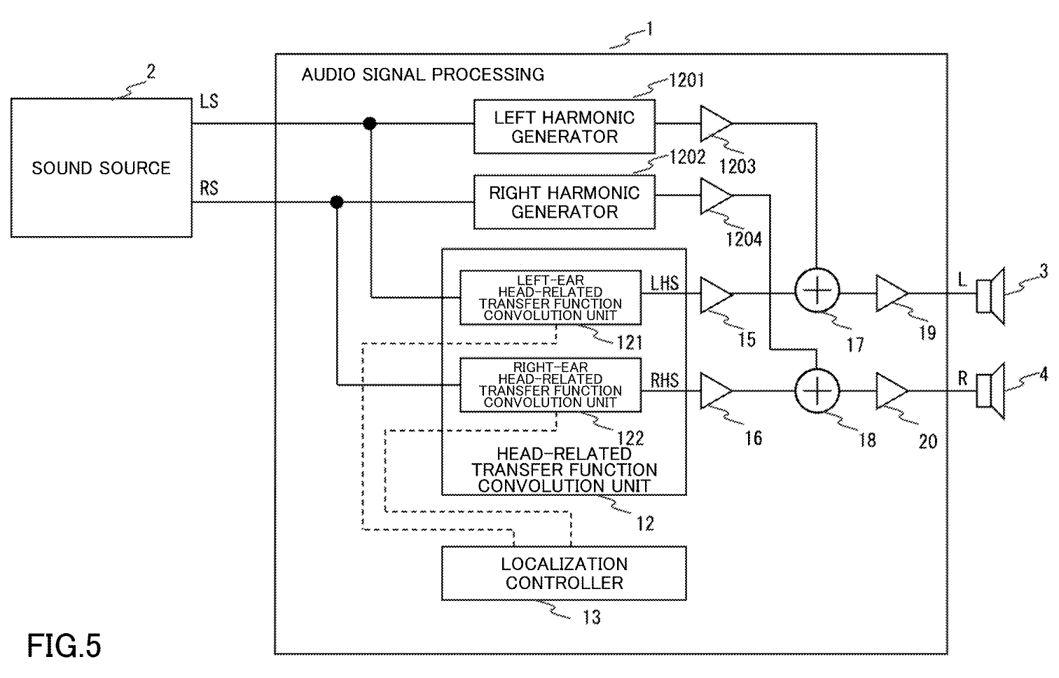

That is, regarding the audio signal processor 1 of FIGS. 1 and 2, in the case where the audio signal S output from the sound source 2 is two channels in the audio signal processor 1 of FIG. 1, as shown in FIG. 5, a left harmonic generator 1201 and a right harmonic generator 1202 are provided instead of the harmonic generator 11 of FIG. 1. The left harmonic generator 1201 and the right harmonic generator 1202 have the same structure and function as the harmonic generator 11 of FIG. 1.

In addition, a left harmonic amplifier 1203 and a right harmonic amplifier 1204 are provided instead of the harmonic amplifier 14 of FIG. 1.

An L-channel audio signal LS output from the sound source 2 is input to the left harmonic generator 1201, and an R-channel audio signal RS output from the sound source 2 is input to the right harmonic generator 1202.

The output of the left harmonic generator 1201 is output to the L-channel synthesizer 17 via the left harmonic amplifier 1203, and the output of the right harmonic generator 1202 is output to the R-channel synthesizer 18 via the right harmonic amplifier 1204.

The L-channel synthesizer 17 synthesizes a signal input from the left harmonic amplifier 1203 and an audio signal LHS input from the L-channel signal amplifier 15, and outputs the synthesized signal to the left speaker 3 via the L-channel output amplifier 19, and the R-channel synthesizer 18 synthesizes a signal AS input from the right harmonic amplifier 1204 and an audio signal RHS input from the R-channel signal amplifier 16, and outputs the synthesized signal to the right speaker 4 via the R-channel output amplifier 20.

Further, in the audio signal processor 1 of FIG. 4, when the audio signal S output from the sound source 2 has two channels, a left harmonic generator 1201 and a right harmonic generator 1202 are provided instead of the harmonic addition unit 111 of FIG. 4. Accordingly, the L-channel audio signal LS output from the sound source 2 is input to the left harmonic generator 1201, and the R-channel audio signal RS output from the sound source 2 is input to the right harmonic generator 1202. Further, the output of the left harmonic generator 1201 is input to the left-ear head-related transfer function convolution unit 121, and the output of the right harmonic generator 1202 is input to the right-ear head-related transfer function convolution unit 122.

In the above description, the audio signal processor 1 outputs signals to the left speaker 3 and the right speaker 4. However, the audio signal processor 1 may instead output signals to an audio recorder, in which the audio signals output from the audio signal processor 1 are recorded.

Further, the audio signal processor 1 can be applied as a part of a game console, a part of an on-vehicle audio system, or the like, in an application for converting a sound effect of a game output as an audio signal S from the sound source 2, a warning sound emitted to a passenger in an automobile, or the like, into a sound effect with a sense of localization.

What is claimed is:

1. An audio signal processor comprising:
a harmonic signal generator configured to generate a harmonic signal that includes a signal generated by frequency scaling components of a target audio signal by a factor of k (k is an integer equal to or more than 2), the target audio signal being an audio signal to be processed;
a left audio signal generator configured to generate a left audio signal by convolving a head-related transfer function from a target localization position of the target audio signal to a left ear of a listener with the target audio signal;
a right audio signal generator configured to generate a right audio signal by convolving a head-related transfer function from the target localization position to a right ear of the listener with the target audio signal;
a left synthesizer configured to generate a left channel audio signal by synthesizing the left audio signal and the harmonic signal; and
a right synthesizer configured to generate a right channel audio signal by synthesizing the right audio signal and the harmonic signal.

2. An audio signal processor comprising:
a harmonic signal generator configured to generate a harmonic signal that includes a signal generated by frequency scaling components of a target audio signal by a factor of k (k is an integer equal to or more than 2), the target audio signal being an audio signal to be processed;
a left harmonic signal generator configured to generate a left harmonic signal by adjusting a gain of the harmonic signal in accordance with a direction of a target localization position of the target audio signal, such that the gain increases as the direction shifts leftward;
a right harmonic signal generator configured to generate a right harmonic signal by adjusting a gain of the harmonic signal in accordance with the direction of the target localization position of the target audio signal, such that the gain increases as the direction shifts rightward;
a left audio signal generator configured to generate a left audio signal by convolving a head-related transfer function from the target localization position to a left ear of a listener with the target audio signal;
a right audio signal generator configured to generate a right audio signal by convolving a head-related transfer function from the target localization position to a right ear of the listener with the target audio signal;
a left synthesizer configured to generate a left channel audio signal by synthesizing the left audio signal and the left harmonic signal; and
a right synthesizer configured to generate a right channel audio signal by synthesizing the right audio signal and the right harmonic signal.

3. An audio signal processor comprising:
a harmonic signal generator configured to generate a harmonic signal that includes a signal generated by frequency scaling components of a target audio signal by a factor of k (k is an integer equal to or more than 2), the target audio signal being an audio signal to be processed;
a harmonic additional signal synthesizer configured to generate a harmonic additional signal by synthesizing the target audio signal and the harmonic signal;
a left channel audio signal generator configured to generate an audio signal of a left channel by convolving a head-related transfer function from a target localization position of the target audio signal to a left ear of a listener with the harmonic additional signal; and
a right channel audio signal generator configured to generate an audio signal of a right channel by convolving a head-related transfer function from the target localization position of the target audio signal to a right ear of the listener with the harmonic additional signal.

4. The audio signal processor according to claim 1, wherein the harmonic signal generator is configured to generate signals, each generated by frequency scaling the components of the target audio signal by a factor of i, i taking integer values from 2 to n (n ≥ k and n > 2), and to generate the harmonic signal by synthesizing the generated signals.

5. An audio signal processor comprising:
a left harmonic signal generator configured to generate a left harmonic signal generated by frequency scaling components of a target left channel signal by a factor of k (k is an integer equal to or more than 2), the target left channel signal being a left channel signal of a target audio signal including left and right channels to be processed;
a right harmonic signal generator configured to generate a right harmonic signal generated by frequency scaling components of a target right channel signal by a factor of L (L is an integer equal to or more than 2), the target right channel signal being the right signal of the target audio signal;
a left audio signal generator configured to generate a left audio signal by convolving a head-related transfer function from a target localization position of the target audio signal to a left ear of a listener with the target left channel signal;
a right audio signal generator configured to generate a right audio signal by convolving a head-related transfer function from the target localization position to a right ear of the listener with the target right channel signal;
a left synthesizer configured to generate a left channel audio signal by synthesizing the left audio signal and the left harmonic signal; and
a right synthesizer configured to generate a right channel audio signal by synthesizing the right audio signal and the right harmonic signal.

6. An audio signal processor comprising:
a left harmonic signal generator configured to generate a left harmonic signal generated by frequency scaling components of a target left channel signal by a factor of k (k is an integer equal to or more than 2), the target left channel signal being a left channel signal of a target audio signal including left and right channels to be processed;
a right harmonic signal generator configured to generate a right harmonic signal generated by frequency scaling components of a target right channel signal by a factor of L (L is an integer equal to or more than 2), the target right channel signal being the right signal of the target audio signal;
a left harmonic additional signal synthesizer configured to generate a left harmonic additional signal by synthesizing the target left channel signal and the left harmonic signal;
a right harmonic additional signal synthesizer configured to generate a right harmonic additional signal by synthesizing the target right channel signal and the right harmonic signal;
a left channel audio signal generator configured to generate a left channel audio signal by convolving a head-related transfer function from a target localization position of the target audio signal to a left ear of a listener with the left harmonic additional signal; and
a right channel audio signal generator configured to generate a right channel audio signal by convolving a head-related transfer function from the target localization position to a right ear of the listener with the right harmonic additional signal.

7. The audio signal processor according to claim 5, wherein:
the left harmonic signal generator is configured to generate signals, each generated by frequency scaling the components of the target left channel signal by a factor of i, i taking integer values from 2 to n (n ≥ k and n > 2), and to generate the left harmonic signal by synthesizing the generated signals; and
the right harmonic signal generator is configured to generate signals, each generated by frequency scaling the components of the target right channel signal by a factor of i, i taking integer values from 2 to m (m ≥ L and m > 2), and to generate the right harmonic signal by synthesizing the generated signals.
